(19) United States
(12) Patent Application Publication
(10) Pub. No.: US 2025/0012894 A1
(43) Pub. Date: Jan. 9, 2025

(54) METHOD FOR CALIBRATING A RADAR SENSOR

(71) Applicant: Robert Bosch GmbH, Stuttgart (DE)

(72) Inventors: Benedikt Loesch, Stuttgart (DE); Arthur Hipke, Leonberg (DE)

(21) Appl. No.: 18/694,056

(22) PCT Filed: Nov. 9, 2022
(86) PCT No.: PCT/EP2022/081289

§ 371 Date: Mar. 21, 2024

(30) Foreign Application Priority Data
Dec. 16, 2021 (DE) 10 2021 214 515.9

(51) Int. Cl. G01S 7/40

(52) U.S. Cl. CPC G01S 7/4021

(57) ABSTRACT

A method for calibrating a radar sensor. The method includes storing an antenna pattern, which assigns a control vector to each of a plurality of angles, before the radar sensor is put into operation; performing radar measurements for one or more targets; respectively storing the receive signals for each target in a measured value vector for the target; calculating the deviation of the measured value vector from the control vector for each target; statistically evaluating the calculated deviations for all targets; and compensating the antenna pattern or the radar measurements with the statistically evaluated deviation.

### FIELD

The present invention relates to a method for calibrating a radar sensor.

### BACKGROUND INFORMATION

In driver assistance systems for motor vehicles, for example in systems for automatic distance control or in collision warning systems, radar sensors are often used to sense the traffic environment. In addition to the distance and the relative speed, the azimuth angle of the located objects is also generally important since the azimuth angle makes lane assignment possible when locating preceding vehicles, for example. The elevation angle of the located objects can also be important since it allows a statement to be made on the relevance of the target, for example whether the target can be driven over or under or represents an obstacle posing a potential collision hazard.

Azimuth and elevation angles of the targets can be ascertained from amplitudes and/or phase differences of transmitting and/or receiving antennas of an antenna array. In the angle estimation, the receive signals are compared to a previously measured angle-dependent antenna pattern. In the case that a single target is located, or in the case that multiple targets that can be clearly distinguished from one another on the basis of the distance and the relative velocity are located, the estimated angle results as the position of the best match (correlation) between the receive signal and the antenna pattern. In the general case of multi-target estimation, special estimation algorithms that provide estimated values for the location angles of all targets involved are known.

Until now, it has been common to measure the antenna patterns for each individual radar sensor at the factory before the radar sensor is put into operation. For this purpose, the measurement data are converted to a predefined format in order to be able to be stored and evaluated on a control device. In so doing, standardizations are carried out. Alternatively, the antenna pattern may also be defined analytically. In so doing, it is assumed that the relative phases are given via the relationship 2π·sin(d_{Rx,TX}/λ), where d_{RX,TX} is the distance of the considered transmitter/receiver combinations in the virtual array. Such an analytical antenna pattern is ascertained purely computationally.

Aging effects, temperature effects, and concealed installation of the radar sensor, for example in a motor vehicle behind a bumper or behind an emblem of the motor vehicle manufacturer, can result in a deviation between the measured antenna pattern and the actually occurring amplitude and phase differences between the transmitting and/or receiving antennas. In principle, such deviations can also occur due to a misalignment of the radar sensor (e.g., elevation misalignment: The plurality of targets has elevation angles that deviate significantly from the azimuth calibration section) or due to imperfect calibration (e.g., in the case of a low number of calibration measurements of the azimuth angle and/or of the elevation angle). These deviations can result in angle errors and in degradation of the correlation value.

The correlation value is, for example, used to detect superposition of multiple targets within a measuring cell and to accordingly activate multi-target angle estimation algorithms in order to detect distortive blindness, i.e., an impairment of the angle measurement capability due to a coating on the radar sensor (e.g., ice, snow, slush), in order to serve as a quality criterion for the reliability of the estimated value, and/or in order to serve as a criterion in object formation (tracking). A degradation of the correlation value due to the effects described above can thus lead to mistakenly increased activation of the multi-target angle estimation algorithms (ghost targets with large angle errors of several degrees) on the one hand and to mistakenly increased detection of distortive blindness on the other hand. A degradation of the correlation value can also impair object formation.

German Patent Application No. DE 10 2014 208 899 A1 describes a method with which a compensation of amplitude and/or phase differences is carried out in a MIMO radar sensor (multiple input multiple output, i.e., a plurality of transmitting antennas and a plurality of receiving antennas) by means of SIMO angle estimations (single input multiple output, i.e., one transmitting antenna and a plurality of receiving antennas) or MISO angle estimations (multiple input single output, i.e., a plurality of transmitting antennas and one receiving antenna).

### SUMMARY

The present invention provides a method for calibrating a radar sensor. According to an example embodiment of the present invention, an antenna pattern for the radar sensor is ascertained and stored in a conventional manner before the radar sensor is put into operation. The antenna pattern assigns a control vector to each of a plurality of angles or angle combinations consisting of azimuth/elevation angle pairs. In this case, it is also possible to store only a few coefficients, from which the control vectors can then be reconstructed. Completely storing entire antenna calibration curves can be provided but is not necessary.

After the radar sensor is put into operation, the radar sensor performs radar measurements for one or more targets. In so doing, suitable targets can be selected for the calibration. For example, only targets whose signal-to-noise ratio exceeds a threshold value can be taken into account in the measurement. The receive signals obtained in the radar measurement are stored in a measured value vector for the respective target.

For each target, the deviation of the measured value vector from the control vector of the antenna pattern is then calculated. For this purpose, the scalar product ŝ of the Hermitian conjugate control vector a^{H}(\hat{θ}) for the angle \hat{θ} and the measured value vector x can preferably be calculated according to Formula 1 below. The deviation Ox can then be calculated according to Formula 2 as the difference between the measured value vector x and the control vector a(\hat{θ}) multiplied by the calculated scalar product s.

$$\hat{s} = {\underline{a}}^{H} ( \hat{θ} ) \cdot \underline{x} \qquad ( Formula 1 )$$

$$Δ \underline{x} = \underline{x} - \hat{s} \cdot \underline{a} ( \hat{θ} ) \qquad ( Formula 2 )$$

The scalar product ŝ for an angle combination consisting of an azimuth/elevation angle pair \hat{θ}, \hat{ϕ} can also be calculated according to Formula 1* from the Hermitian conjugate control vector a^{H}(\hat{θ}, \hat{ϕ}) for the azimuth/elevation angle pair \hat{θ}, \hat{ϕ} and the measured value vector x. The deviation Δx can then be calculated according to Formula 2 as the difference between the measured value vector x and the control vector a(\hat{θ}, \hat{ϕ}) multiplied by the calculated scalar product ŝ.

$$\hat{s} = {\underline{a}}^{H} ( \hat{θ} , \hat{ϕ} ) \cdot \underline{x} \qquad ( Formula 1 \text{*)}$$

$$Δ \underline{x} = \underline{x} - \hat{s} \cdot \underline{a} ( \hat{θ} , \hat{ϕ} ) \qquad ( Formula 2 \text{*)}$$

Subsequently, a statistical evaluation of the calculated deviations for all selected targets takes place. In so doing, the calculated deviations can be averaged or the median of the calculated deviation can be calculated. In the averaging, the calculated deviations can additionally be weighted via the respective signal-to-noise ratio of the associated target. Alternatively, a histogram may be created for the statistical evaluation.

Finally, the antenna pattern or the radar measurements are compensated with the statistically evaluated deviation. In so doing, either the antenna pattern calculated or measured in advance is compensated or future radar measurements are directly compensated. For radar sensors that can simultaneously sense a plurality of targets, a further processing step can be provided in which the compensation of the current radar measurements is carried out in the same cycle in which the statistically evaluated deviations are calculated. This is in particular useful if a coating (e.g., ice, snow, slush) on the radar sensor has been detected and the radar measurements are nevertheless to be carried out as best as possible.

Misalignment of the radar sensor results in most objects no longer being located in the calibration plane (for example, in the case of an elevation angle of 0° in sensor coordinates). This leads to angle errors that cannot be compensated even if misalignment has been ascertained perfectly. Since physical misalignment and distortion of the antenna pattern cannot be distinguished from one another, the angle errors as a result of distortion of the antenna pattern are not compensated directly. The described calibration of the radar sensor compensates amplitude and/or phase deviations from the antenna pattern and thus the degradation of the correlation value. This improves activation of the multi-target angle estimation algorithms and detection of distortive blindness. In addition, object formation, which is also impaired by the degradation of the correlation value, is improved.

Only the azimuth angle, or optionally the elevation angle, can be considered in the compensation. Alternatively, azimuth/elevation angle pairs may also be considered in the compensation. In this case, a two-dimensional compensation (2D compensation map), which depends on the azimuth angle and on the elevation angle, is achieved.

The compensation can be applied to all angles so that the amplitude and/or phase deviations are compensated for the entire angular range over which the radar sensor measures. Such a global compensation can be applied to both the antenna pattern and the radar measurements, as described above. In the global compensation, the radar measurement for one target is already sufficient to calculate the deviation.

Alternatively, according to an example embodiment of the present invention, an angle-dependent compensation may be provided, in which the amplitude and/or phase deviations are compensated for specified angle intervals. The different angular ranges with different deviations can thereby be individually compensated. Such a compensation can be applied only to the antenna pattern. In the angle-dependent compensation, radar measurements are carried out for multiple targets. In particular, one or more targets are measured for each angle interval.

According to an example embodiment of the present invention, in order to avoid that the compensation mistakenly has an effect in the case of distortive blindness, the deviations can be recorded and statistically evaluated over a significant longer period of time than is provided for the detection of distortive blindness.

The calibration can also be carried out individually for different temperature ranges. In so doing, the deviation is calculated and the compensation is carried out separately for each temperature range, as described above. As a result, temperature effects resulting in rapid changes can also be compensated. The temperature is preferably ascertained by means of a temperature sensor, which is typically already available in the radar sensor.

### BRIEF DESCRIPTION OF THE DRAWINGS

Exemplary embodiments of the present invention are shown in the figures and explained in more detail in the following description.

FIG. 1 shows a flowchart of a first exemplary embodiment of the method according to the present invention.

FIG. 2 shows a flowchart of a second exemplary embodiment of the method according to the present invention.

### DETAILED DESCRIPTION OF EXAMPLE EMBODIMENTS

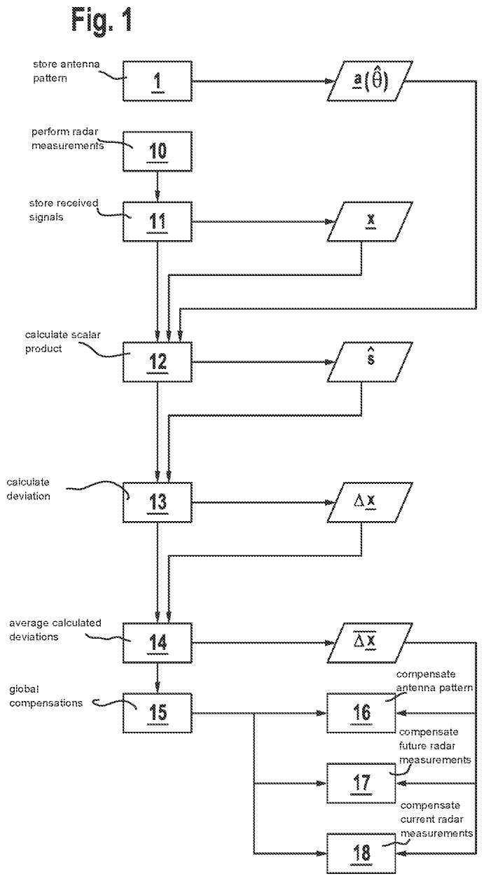

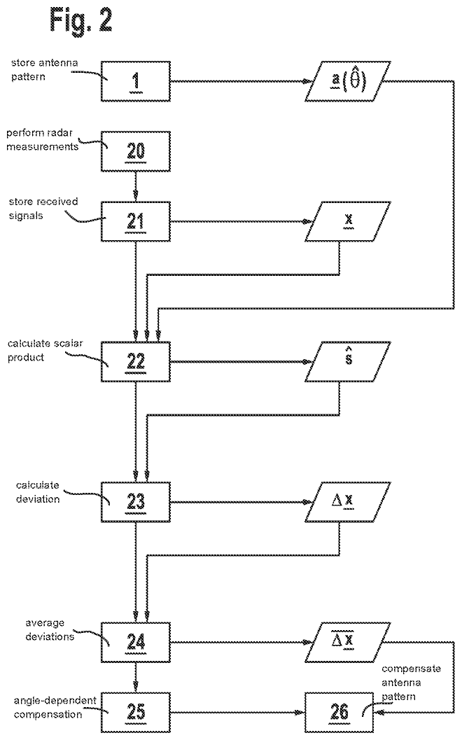

FIGS. 1 and 2 respectively show a flowchart of an exemplary embodiment of the method according to the present invention for calibration of a radar sensor. In both cases, an antenna pattern for the radar sensor is stored 1 before the radar sensor is put into operation. The antenna pattern assigns a control vector a(\hat{θ}) to each of a plurality of angles \hat{θ}. The angle \hat{θ} is the azimuth angle in this exemplary embodiment. In further exemplary embodiments not shown, the angle can also be the elevation angle. In other exemplary embodiments, also not shown, a plurality of angle combinations of the azimuth angle and of the elevation angle are used instead of the plurality of angles \hat{θ}.

In the first exemplary embodiment in FIG. 1, after being put into operation, the radar sensor performs radar measurements 10 for one or more targets in this exemplary embodiment. In so doing, suitable targets are selected for the calibration, for example targets whose signal-to-noise ratio exceeds a threshold value. The receive signals obtained during the radar measurement 10 are stored 11 in a measured value vector x for the respective target. The scalar product s of the Hermitian conjugate control vector a^{H}(\hat{θ}) of the antenna pattern and the measured value vector x is calculated 12 according to Formula 1. Subsequently, the difference between the measured value vector x and the control vector a(\hat{θ}) of the antenna pattern multiplied by the scalar product ŝ is formed 13 according to Formula 2 and a deviation Δx is thus calculated:

$$\hat{s} = {\underline{a}}^{H} ( \hat{θ} ) \cdot \underline{x} \qquad ( Formula 1 )$$

$$Δ \underline{x} = \underline{x} - \hat{s} \cdot \underline{a} ( \hat{θ} ) \qquad ( Formula 2 )$$

Subsequently, the calculated deviations Δx are averaged 14 over all targets and an average deviation [symbol] is obtained. In the averaging, the calculated deviations can be weighted via the respective signal-to-noise ratio of the associated target. Alternatively, other types of statistical evaluation, e.g., a median calculation or a histogram, may be used.

In this first exemplary embodiment, a global compensation 15 takes place, in which the amplitude and/or phase deviations are compensated for all angular ranges. In so doing, either the antenna pattern is compensated 16 with the average deviation [symbol] . Or, future radar measurements are compensated 17 with the average deviation [symbol] . In addition, if the radar sensor simultaneously senses a plurality of targets, the current radar measurements are compensated 18 in the same cycle.

The second exemplary embodiment in FIG. 2 differs from the first exemplary embodiment in that different angular ranges are examined individually. After the radar sensor is put into operation, the radar sensor in this exemplary embodiment performs radar measurements 20 for multiple targets located in different angular ranges. Subsequently, the receive signals are also stored 21 for each target in a measured value vector x, a deviation Δx is calculated 22, 23 for each target according to the aforementioned formulas 1 and 2, and the deviations Δx are averaged 24 over all targets in order to obtain an average deviation [symbol] , or are statistically evaluated in another way, as described above. Reference is made to the description of the first exemplary embodiment.

In this second exemplary embodiment, an angle-dependent compensation 25 takes place, in which the amplitude and/or phase deviations are only compensated for specified angle intervals.

In so doing, the antenna pattern is compensated 26 with the average deviation [symbol] .

In both exemplary embodiments, steps 10 to 18 or 20 to 26 can be repeated for different temperature ranges.

1-4. (canceled)

5. A method for calibrating a radar sensor, comprising the following steps:
before the radar sensor is put into operation: storing an antenna pattern that makes an assignment of a control vector possible;
performing radar measurements for one or more targets;
respectively storing receive signals for each target in a measured value vector for the target;
calculating a deviation of the measured value vector from the control vector for each target;
statistically evaluating the calculated deviations for all targets; and
compensating the antenna pattern or the radar measurements with the statistically evaluated deviation.

6. The method according to claim 5, wherein, in the calculation of the deviation of the measured value vector from the control vector, a scalar product of a Hermitian conjugate control vector and the measured value vector is calculated, and the deviation is calculated as a difference between the measured value vector and the control vector multiplied by the calculated scalar product.

7. The method according to claim 5, wherein an angle-dependent compensation of the antenna pattern with the statistically evaluated deviation takes place.

8. The method according to claim 5, wherein the calibration takes place for angle combinations including of an azimuth angle and an elevation angle.
